(19) United States
(12) Patent Application Publication
(10) Pub. No.: US 2004/0222934 A1
(43) Pub. Date: Nov. 11, 2004

(54) Multi-mode, multi-choke feed horn

(75) Inventor: Te-Kao Wu, Rancho Palos Verdes, CA (US)

Correspondence Address: John A. Miller, Warn, Burgess & Hoffmann, P.C., P.O. Box 70098, Rochester Hills, MI, 48307, US

(73) Assignee: Northrop Grumman Corporation, Los Angeles, CA (US)

(21) Appl. No.: 10/430,833

(22) Filed: May 6, 2003

(51) Int. Cl. H01Q 13/00

(52) U.S. Cl. 343/786

(57) ABSTRACT

A multi-mode, multi-choke feed horn that employs a plurality of chokes designed to excite the proper mode content in a satellite uplink signal or downlink signal over a particular wide bandwidth. In one embodiment, the feed horn includes five chokes, where the choke closest to the feed end of the horn has a depth of about 0.075″.

### BACKGROUND OF THE INVENTION

1. Field of the Invention

This invention relates generally to an antenna feed horn and, more particularly, to a multi-mode antenna feed horn for a satellite that employs multiple chokes for providing high gain over a wide bandwidth.

2. Discussion of the Related Art

Various communication networks, such as Ka-band satellite communications networks, employ satellites orbiting the Earth in a geosynchronous orbit. A satellite uplink communications signal is transmitted to the satellite from one or more ground stations, and then is switched and retransmitted by the satellite to the Earth as a downlink communications signal to cover a desirable reception area. The uplink and downlink signals are transmitted at a carrier frequency within a particular frequency bandwidth and are coded. The bandwidth for these types of satellite communications uplink and downlink signals is generally in the 20-30 GHz range, where the uplink signal is in the 28-30 GHz.

Both commercial and military Ka-band communication satellite networks require a high effective isotropic radiated power (EIRP) in the downlink signal, and an acceptable gain versus temperature ratio (G/T) in the uplink signal for the communications link. The EIRP and acceptable G/T require a high gain antenna system providing a smaller beam size, thus reducing the beam coverage and requiring a multi-beam antenna system. The satellite is therefore equipped with an antenna system that includes a plurality of antenna feed horns arranged in a predetermined configuration that receive the uplink signals and transmit the downlink signals to the Earth over a predetermined field-of-view.

The antenna system must provide a beam scan capability up to fifteen beamwidths away from the antenna boresight with a low scan loss and minimal beam distortion in order to compensate for the longer path length losses at the edges of the field-of-view. Multi-beam antenna systems that produce a system of contiguous beams by the plurality of feed horns require highly circular beam symmetry, steep main beam roll-off, suppressed sidelobes and low cross-polarization to achieve low interference between adjacent beams. To provide maximum signal strength intensity independent of the user's orientation, it is necessary that the communications signals be circularly polarized.

To accomplish the above-stated parameters, the antenna feed horns must be capable of producing beam radiation patterns that have substantially equal E-plane and H-plane beamwidths over the operating frequency band of the signal. The level of the cross-polarization and the ratio of the E-plane beamwidth to the H-plane beamwidth in the downlink or uplink signal determine the axial ratio of the signal. If the cross-polarization is substantially negligible and the E-plane and H-plane beamwidths are substantially the same, the axial ratio is about one and the signals are effectively circularly polarized. However, if the E-plane and H-plane beamwidths are significantly different, the signal is elliptically polarized and the received signal strength is reduced, causing increased insertion loss and data rate loss of the uplink or downlink signal.

The useable bandwidth of the downlink signal that is able to transmit information is determined by the combination of the various propagation modes (amplitude and phase) over frequency in the horn aperture. These feed horn propagation modes include the transverse electric (TEₘₙ) modes and the transverse magnetic (TMₘₙ) modes. Various known conical shaped feed horns for satellite antenna systems are typically limited to the fundamental (TE₁₁) mode content for the communications signal and have a high axial ratio.

U.S. Pat. No. 6,208,310 issued Mar. 27, 2001 to Suleiman et al., and assigned to the assignee of this application, discloses a multi-mode, multi-choke antenna feed horn that provides substantially equal E-plane and H-plane beamwidths, low cross-polarization and suppressed sidelobes. The feed horn disclosed in the '310 patent employs five annular chokes to provide the desired gain over a relatively wide bandwidth, for example 28-30 GHz, suitable for the antenna systems discussed above. Each choke in the horn provides the antenna gain for a certain portion of the frequency band, where the combined chokes provide the wide bandwidth.

However, the working embodiment of the feed horn disclosed in the '310 patent has been shown to be too sensitive at the lower end (28-28.5 GHz) of the desired frequency band because the choke used to provide the gain at that frequency did not have the best depth. Because this choke did not have the proper depth, higher order propagation modes were significantly excited by the feed horn for that portion of the frequency band, so that the mode content percentage of the desired fundamental TE₁₁ mode was reduced, thus reducing the gain of the antenna at those frequencies.

### SUMMARY OF THE INVENTION

In accordance with the teachings of the present invention, a multi-mode antenna feed horn for a satellite is disclosed that employs a plurality of chokes designed to excite the fundamental propagation mode and suppress the high order modes in a satellite uplink signal or downlink signal over a relatively wide bandwidth. The feed horn provides substantially equal E-plane and H-plane beamwidths, low cross-polarization and suppressed sidelobes. In one embodiment, the feed horn includes five chokes, where the choke closest to the feed end of the horn has a depth in the range 0.070″-0.080″, and preferably about 0.075″. Further, the chokes provide high gain over the frequency band 28-30 GHz.

Additional advantages and features of the present invention will become apparent from the following description and appended claims, taken in conjunction with the accompanying drawings.

### BRIEF DESCRIPTION OF THE DRAWINGS

FIG. 1 is a perspective view of a multi-mode, multi-choke antenna feed horn, according to an embodiment of the present invention;

FIG. 2 is a cross-sectional view of the antenna feed horn shown in FIG. 1; and

FIG. 3 is a graph with frequency on the horizontal axis and gain on the vertical axis comparing the gain of the multi-mode, multi-choke antenna feed horn of the invention and a known multi-mode, multi-choke antenna feed horn.

### DETAILED DESCRIPTION OF THE INVENTION

The following discussion of the embodiments of the invention directed to a multi-mode, multi-choke antenna feed horn for a satellite antenna array is merely exemplary in nature, and is in no way intended to limit the invention or its applications or uses.

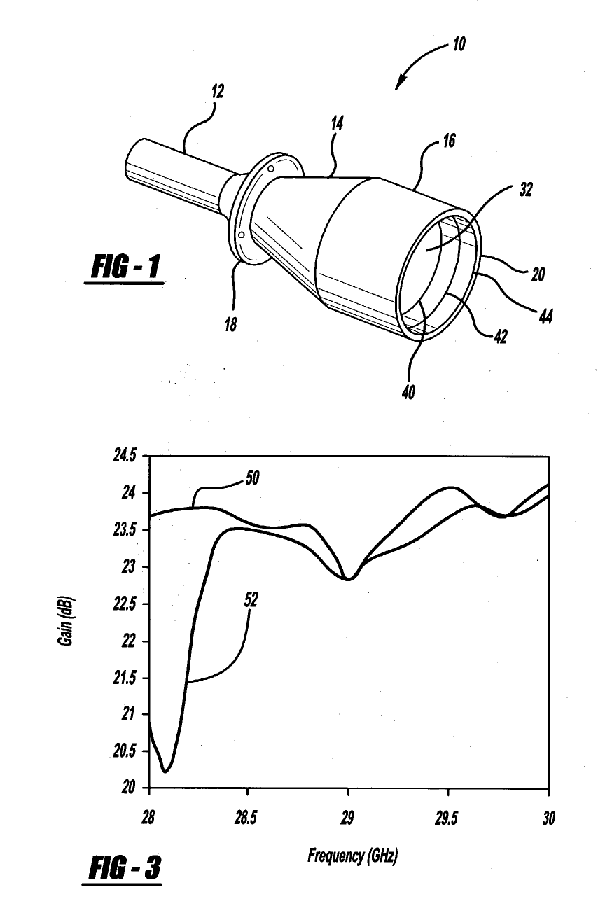

FIG. 1 is a perspective view and FIG. 2 is a cross-sectional view of an antenna feed horn 10, according to the invention. The feed horn 10 could be one of a plurality of antenna feed horns associated with an antenna array used in connection with a satellite communications network that is operating, for example, in the Ka frequency band. The antenna system can take on any suitable configuration and optical geometry for this type of communications network, such as a side-fed antenna system, a front-fed antenna system, a cassegrain antenna system, and a Gregorian antenna system. The design of the feed horn 10 is not limited to a particular communications network or antenna system, but has a wider application for many types of communications systems and networks. Additionally, the discussion of the feed horn 10 below will be directed to using the feed horn 10 for the uplink signal of the satellite communications network. The feed horn 10 will receive a signal having a frequency consistent with the communications network, such as the Ka frequency bandwidth, but can be used for any applicable frequency bandwidth, both commercial and military, including the Ku-band.

The antenna feed horn 10 includes a throat section 12, a profile section 14 and an aperture section 16 that form a single unit. An input end of the throat section 12 would be connected to a signal waveguide (not shown), which would be connected to a beam generating system (not shown), as would be well understood to those skilled in the art. The signal travels from the waveguide through the throat section 12 and expands through the profile section 14. The expanded signal then exits the feed horn 10 at an aperture mouth 20 opposite to the throat section 12. An annular mounting flange 18 encircles the profile section 14 and provides a mechanism for mounting the horn 10 to an antenna support structure (not shown).

As will be discussed in detail below, the configuration of the inside of the horn 10 provides a high propagation mode content of the fundamental TE₁₁ mode, while suppressing the higher order modes at the horn aperture and suppressing undesirable interfering sidelobes. The horn 10 also generates substantially equal E-plane and H-plane beamwidths with low cross-polarization and low phase center variation across a relatively wide bandwidth.

The external surface of the throat section 12 is cylindrical, and the internal surface of the throat section 12 includes a cylindrical throat portion 22 proximate an input end 24 of the horn 10. The signal propagating through the cylindrical portion 22 expands in a first expanding throat transition portion 26 connected to the cylindrical portion 22 and a second expanding throat transition portion 28 connected to the transition portion 26, as shown. The first and second expanding portions 26 and 28 gradually widen the opening of the feed horn 10 from the input end 24, so that the combination of the throat portions 22, 26 and 28 act to lower the cross-polarization of the frequency signal to lessen interference between adjacent beams generated by the antenna system. The expanding portions 26 and 28 are specially designed to be different and have the shape as shown to provide this function. The expanding portion 28 continues to expand into the profile section 14. The profile section 14 has an outer conical surface and an inner profile surface 30 defined by a sine-squared function. The advantage of choosing such a profile geometry is providing a horn that is compact in size, shorter in length, and thus lower in weight.

The outer surface of the aperture section 16 is cylindrical. An aperture inner surface 32 of the aperture section 16 is generally cylindrical, and includes a series of strategically configured and positioned chokes, according to the invention. Particularly, a first choke 34 and a second choke 36 are formed at the transition location between the inner profile surface 30 and the inner aperture surface 32. Both of the chokes 34 and 36 are annular notches formed in the inner surface 32 of the horn 10 that have radial and axial dimensions selected by a horn optimization process depending on the frequency and bandwidth of the signal desired. As is apparent, the chokes 34 and 36 are adjacent to each other and separated by a common wall 38, where the annular choke 36 has a larger diameter and is outside of the annular choke 34.

The inner surface 32 of the aperture section 16 also includes chokes 40, 42 and 44 proximate the mouth 20 of the aperture section 16. The choke 44 is formed in the end of the horn 10 at the mouth 20, and the chokes 40 and 42 are formed in the surface 32, as shown. Each of the chokes 40, 42 and 44 are also annular notches having tightly controlled radial and axial dimensions, where the diameter of the choke increases from the choke 40 to the choke 44, as shown. The chokes 40, 42 and 44 are spaced apart from each other a predetermined amount, as shown, and have a narrower radial dimension than the chokes 34 and 36.

The internal diameter of the throat section 12 relative to the wavelength λ of the signal being transmitted mostly only allows propagation of the lower fundamental TE₁₁ mode. In order for the E-plane beamwidth to match the H-plane beamwidth, a discontinuity must be provided within the horn 10 that expands the propagation diameter of the horn 10. The chokes 34, 36, 40, 42 and 44 provide this discontinuity. The chokes 34, 36, 40, 42 and 44 act to absorb surface currents to help equalize the E-plane and H-plane beamwidths, suppress the sidelobes and lower the cross-polarization. The chokes 34, 36, 40, 42 and 44 also combine to control the mode content at the mouth 20 to provide an output signal that has low cross-polarization, low sidelobes, low return loss is circularly polarized and has an operational bandwidth over 28-30 GHz.

According to the present invention, the choke 34 has a depth in the range of 0.070-0.080″, and particularly 0.075″ in one embodiment. By providing the choke 34 with this depth, the fundamental TE₁₁ mode is mostly excited, so that most of the propagation mode content of the signal is in that mode, and the higher order modes are not significantly excited. This provides high gain for the frequency range controlled by the choke 34, i.e., 28-28.5 GHz. In one embodiment, the choke 36 has a depth of 0.060″, and the chokes 40, 42 and 44 have a depth of 0.1004″.

In the working embodiment of the antenna feed horn disclosed in the '310 patent, the first choke that controlled the mode content of the lower end of the frequency band 28-30 GHz had a depth of 0.061″. However, this depth made the feed horn too sensitive. Particularly, the depth was incorrect to provide the desired gain at the 28-28.5 GHz frequency range because higher order modes were significantly excited in that frequency range, so that too much of the signal propagation mode content occurred in the higher propagation modes and too little occurred in the TE₁₁ mode.

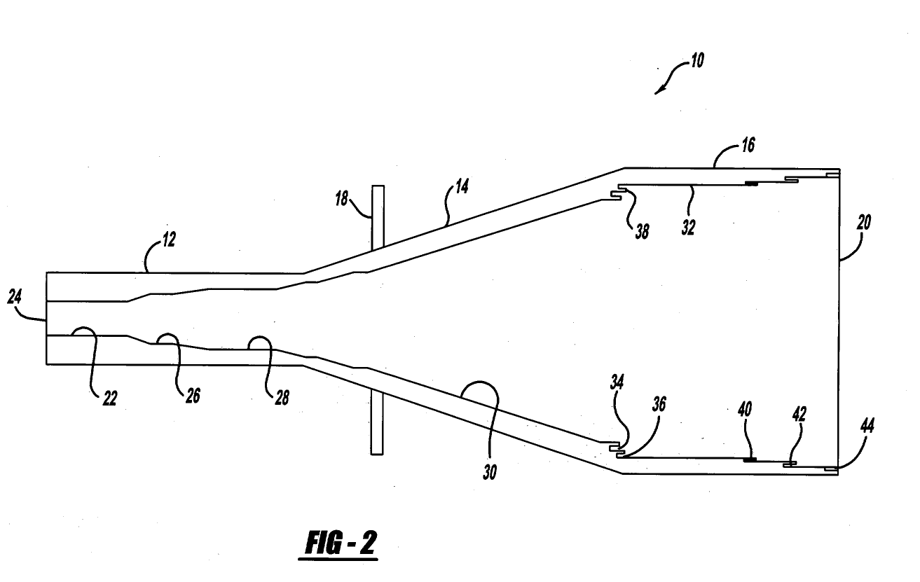

FIG. 3 is a graph with frequency on the horizontal axis and gain on the vertical axis showing a comparison between the antenna feed horn 10 of the invention discussed above and the antenna feed horn disclosed in the '310 patent. Graph line 50 shows the gain of the antenna feed horn 10 discussed above, and graph line 52 shows the gain of the antenna feed horn disclosed in the '310 patent. As is apparent, the antenna feed horn 10 of the invention provides suitable gain across the entire 28-30 GHz frequency range and the antenna feed horn of the '310 patent has unacceptable gain in the 28-28.5 GHz frequency range that is controlled by the first choke.

Table I below shows a comparison of the propagating mode content at 28.2 GHz of the feed horn 10 and the feed horn disclosed in the '310 patent. The first column shows the propagating mode, the second column shows the mode content percent for each propagating mode for the feed horn 10 where the choke 34 has a depth of about 0.075″, and the third column shows the mode content percent for each propagating mode for the feed horn of the '310 patent where the first choke has a depth of 0.061″. As is apparent, the feed horn 10 of the '310 patent provides a significant propagation mode content percent for the TM₁₁ and TM₁₃ modes that reduces the propagation mode content of the desired TE₁₁ mode to about 50.68%. However, for the multi-mode feed horn 10 where the first choke 34 has a depth of about 0.075″, the propagation mode content percent for the TE₁₁ mode is 81.43%, thus providing the desired gain at 28.2 GHz.

TABLE I

| | |
|---|---|
| Propagating | First Choke Depth (″) |

| modes | 0.075 | 0.061 |
|---|---|---|
| TE11 | 81.43% | 50.68% |
| TE12 | 5.74 | 3.54 |
| TE13 | 0.37 | 0.16 |
| TE14 | 0.80 | 0.54 |
| TE15 | 0.05 | 0.14 |
| TM11 | 4.39 | 11.22 |
| TM12 | 0.67 | 1.05 |
| TM13 | 4.58 | 29.55 |
| TM14 | 0.55 | 0.56 |
| TM15 | 0.96 | 0.05 |

Table II below shows a comparison of the feed horn 10 and the feed horn of the '310 patent at 28.2 GHz for primary gain, return loss, peak sidelobe level and cross-polarization level. As is apparent, the feed horn 10 where the choke 34 has a depth of about 0.075″ provides greater performance than the feed horn of the '310 patent where the first choke has a depth of 0.061″.

TABLE II

| Fist Choke | Primary | Return | Peak Sidelobe | Cross-polarization |
|---|---|---|---|---|
| Depth (″) | Gain (dB) | Loss (dB) | level (dB) | level (dB) |
| 0.075 | 23.78 | 22.4 | −17 | −23.5 |
| 0.061 | 21.78 | 16.78 | −11 | −16.6 |

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A feed horn for transmitting a signal, said horn comprising:
a throat section for receiving the signal;
a profile section coupled to the throat section; and
an aperture section coupled to the profile section and defining an aperture of the horn, said aperture section including a plurality of chokes that are formed in an internal wall of the aperture section, said plurality of chokes including at least one choke positioned at a transition location between the profile section and the aperture section and being the closest choke to the throat section, said at least one choke having a depth in the range of 0.070-0.080″.

2. The feed horn according to claim 1 wherein the at least one choke has a depth of 0.075″.

3. The feed horn according to claim 1 wherein the plurality of chokes is five chokes.

4. The feed horn according to claim 1 wherein the signal is in the frequency band of 28-30 GHz.

5. The feed horn according to claim 1 wherein the plurality of chokes alter the mode content of the signal to create substantially equal E-plane and H-plane beamwidths with suppressed sidelobes and low cross-polarization.

6. The feed horn according to claim 1 wherein the plurality of chokes are annular notches formed in the internal wall of the aperture section.

7. The feed horn according to claim 1 wherein the plurality of chokes includes a first choke and a second choke positioned at the transition location between the profile section and the aperture section, said first and second chokes including a common wall therebetween.

8. The feed horn according to claim 1 wherein the plurality of chokes is five chokes, including two chokes positioned at the transition location between the profile section and the aperture section, another choke formed in the aperture, and two other chokes formed at intermediate locations between the aperture and the transition location between the profile section and the aperture section.

9. The feed horn according to claim 1 wherein the throat section includes an outer surface that is generally cylindrical and an inner surface that includes a cylindrical portion and at least one expanding portion that expands the inside of the throat section.

10. The feed horn according to claim 1 wherein the throat section has a general cylindrical shaped outer surface, the profile section has a general conical shaped outer surface, and the aperture section has a general cylindrical shaped outer surface.

11. A feed horn for transmitting a signal, said feed horn comprising an outer wall defining a chamber and including a plurality of chokes that are formed in an internal wall of the chamber, said plurality of chokes including at least one choke having a depth in the range of 0.070-0.080″.

12. The feed horn according to claim 11 wherein the at least one choke has a depth of 0.075″.

13. The feed horn according to claim 11 wherein the plurality of chokes is five chokes.

14. The feed horn according to claim 11 wherein the signal is in the frequency band of 28-30 GHz.

15. The feed horn according to claim 11 wherein the plurality of chokes alter the mode content of the signal to create substantially equal E-plane and H-plane beamwidths with suppressed sidelobes and low cross-polarization.

16. The feed horn according to claim 11 wherein the feed horn is part of a satellite communications system and receives a satellite uplink signal.

17. A feed horn for receiving a signal on a satellite, said horn comprising:
a throat section for receiving the signal;
a profile section coupled to the throat section; and
an aperture section coupled to the profile section and defining an aperture of the horn, said aperture section including a plurality of chokes that are formed in an internal wall of the aperture section, said plurality of chokes including two chokes positioned at the transition location between the profile section and the aperture section, another choke formed in the aperture, and two other chokes formed at intermediate locations between the aperture and the transition location between the profile section and the aperture section, wherein the choke closest to the throat section having a depth of about 0.075″, wherein the plurality of chokes alter the mode content of the signal to create substantially equal E-plane and H-plane beamwidths with suppressed sidelobes and low cross-polarization.

18. The feed horn according to claim 17 wherein the plurality of chokes are annular notches formed in the internal wall of the aperture section.

19. The feed horn according to claim 17 wherein the throat section has a general cylindrical shaped outer surface, the profile section has a general conical shaped outer surface, and the aperture section has a general cylindrical shaped outer surface.

20. The feed horn according to claim 17 wherein the throat section includes an outer surface that is generally cylindrical and an inner surface that includes a cylindrical portion and at least one expanding portion that expands the inside of the throat section.
